(19) United States
(12) Patent Application Publication
(10) Pub. No.: US 2026/0209587 A1
(43) Pub. Date: Jul. 23, 2026

(54) MAGNESIUM OXIDE PARTICLES AND PRODUCTION METHOD THEREOF

(71) Applicant: Ube Material Industries, Ltd., Ube-shi, Yamaguchi (JP)

(72) Inventors: Ryo YOSHIMATSU, Yamaguchi (JP); Takashi ARASE, Yamaguchi (JP); Yuji UEDA, Yamaguchi (JP); Naoto NISHIDA, Yamaguchi (JP)

(21) Appl. No.: 18/725,445

(22) PCT Filed: Jan. 17, 2023
(86) PCT No.: PCT/JP2023/001238

§ 371 Date: Sep. 24, 2025

(30) Foreign Application Priority Data
Jan. 28, 2022 (JP) 2022-012150

(51) Int. Cl. C09K 5/14; C01F 5/02; C08K 7/18

(52) U.S. Cl. CPC C09K 5/14; C01F 5/02; C08K 7/18; C01P 2004/03; C01P 2004/32; C01P 2004/61; C01P 2006/12; C01P 2006/19; C01P 2006/32; C08K 2201/001; C08K 2201/005; C08K 2201/006

(57) ABSTRACT

The magnesium oxide particle of the present invention includes a spherical particle, the spherical particle including a plurality of dead-burned magnesium oxide particles, the dead-burned magnesium oxide particles being partially fused together in such a manner that open pores remain between the dead-burned magnesium oxide particles, the spherical particle having an average particle size (D2) of 10 μm or more and 200 μm or less, and the spherical particle having a projected image having a circularity of 0.7 or more. The spherical particles preferably have a porosity of 10% or more and 50% or less as determined by image analysis. The spherical particles preferably have a ratio of the average particle size D2 to the BET specific surface area-based equivalent particle size D1, D2/D1, of 3 or more and 10 or less.

### TECHNICAL FIELD

The present invention relates to magnesium oxide particles and a method for producing the same.

### BACKGROUND ART

Known applications of magnesium oxide include thermally conductive fillers. Patent literature 1 listed below proposes spherical magnesium oxide particles to provide a thermal conductive filler with improved loading properties and thereby enhanced thermal conductivity.

Acicular magnesium oxide particles with high aspect ratios have also been proposed for improving formability of a thermal conductive path (see patent literature 2).

### CITATION LIST

### Patent Literature

Patent literature 1: JP 2016-088838A
Patent literature 2: JP 2020-152613A

### SUMMARY OF INVENTION

Spherical magnesium oxide particles as disclosed in patent literature 1 have excellent filling properties, and resin compositions obtained by highly filling a resin with them have high thermal conductivity. However, a resin composition highly loaded with magnesium oxide particles has the problem of increased specific gravity due to the higher density of magnesium oxide than resins. In addition, it is economically disadvantageous to compose a large amount of spherical magnesium oxide particles, which are generally more expensive than resins.

Acicular magnesium oxide particles with high aspect ratios easily form thermal conduction paths and, when the acicular magnesium oxide particles are composed into resins, resin compositions with increased rigidity are provided. However, when high rigidity is not required of a resin composition, there is no need to use acicular magnesium oxide particles. Furthermore, because acicular magnesium oxide particles are generally fragile, they are difficult to knead into resins.

An object of the present invention is to provide magnesium oxide particles that are easier to knead into resins than acicular magnesium oxide particles of high aspect ratios and exhibit high thermal conductivity when composed into resins even at not so high filling ratios, and do not result in excessively high specific gravity of the resulting resin compositions.

As a result of intensive study, the inventors have found that particles granulated from dead-burned magnesium oxide particles have a spherical shape that is close to a true sphere and have a structure containing internal thermal conductive paths and voids, and therefore, thereby the particles have a high thermal conductivity and a reduced apparent density. The present invention has been completed on the basis of these findings.

The present invention provides a magnesium oxide particle comprising a spherical particle,
the spherical particle comprising a plurality of dead-burned magnesium oxide particles,
the dead-burned magnesium oxide particles being partially fused together in such a manner that open pores remain between the dead-burned magnesium oxide particles,
the spherical particle having an average particle size (D2) of 10 μm or more and 200 μm or less, and
the spherical particle having a projected image having a circularity of 0.7 or more.

The present invention also provides a method for producing magnesium oxide particles, comprising
granulating a raw material composition comprising: dead-burned magnesium oxide particles having an average particle size of 1.0 μm or more and 20.0 μm or less; and a flux to form granulated particles, and
firing the granulated particles at 900° C. or higher and 1700° C. or lower.

### BRIEF DESCRIPTION OF DRAWINGS

FIG. 1 is an SEM image of a magnesium oxide particle obtained in Example 1.

FIG. 2 is an SEM image of a magnesium oxide particle obtained in Comparative Example 1.

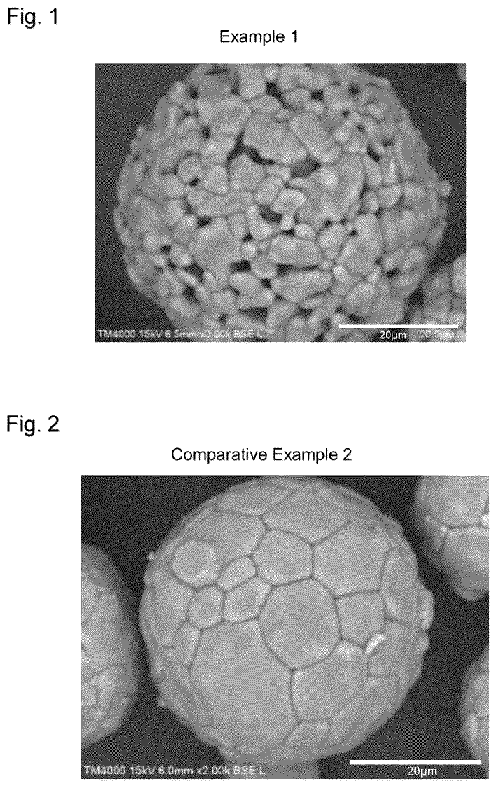

### DESCRIPTION OF EMBODIMENTS

The present invention will be described on the basis of its preferred embodiments.

The present invention relates to magnesium oxide particles. One of the characteristics of the magnesium oxide particles of the present invention is that they have a reduced apparent density while retaining the advantage of high thermal conductivity which a magnesium oxide intrinsically has. The low apparent density of the magnesium oxide particles of the present invention is attributed to a great number of voids inside the individual particles. In detail, the magnesium oxide particle of the present invention is a spherical particle formed of a plurality of dead-burned magnesium oxide particles partially fused together while leaving voids among the dead-burned magnesium oxide particles. The primary magnesium oxide particles that form the spherical particle will be described below. As used herein, the term “particles” means either individual particles or powder as an aggregate of particles according to the context.

### 1. Dead-Burned Magnesium Oxide Particles

The magnesium oxide particle of the present invention has a fused body composed of a plurality of dead-burned magnesium oxide particles partially fused together. In what follows, the term “primary magnesium oxide particles” denotes individual particles composing the spherical particle surrounded by the grain boundaries along which it is fused to other particles and a void or voids.

As used hereinafter, the term “starting particles” refers to particles to be used in the step for producing granulated particles described below. The starting particles preferably have an average particle size of 1.0 μm or more and 20.0 μm or less. When the starting particles have an average particle size of 1.0 μm or more, the progress of sintering of the granulated particles can be controlled after firing as described below, thereby allowing sufficient voids and pores to remain between the primary particles, and the granulated particles can easily maintain their spherical shape after sintering. When the starting particles have an average particle size of 20.0 μm or less, it is easier to obtain magnesium oxide particles with a shape close to a true sphere after firing as described below. From these points of view, the average particle size of the starting particles is more preferably 3.0 μm or more and 15.0 μm or less, even more preferably 5.0 μm or more and 10.0 μm or less.

In order for the granulated particles to retain voids after firing as described below, the starting particles preferably have a BET specific surface area of 2.0 m²/g or less, more preferably 0.09 m²/g or more and 1.8 m²/g or less, even more preferably 0.09 m²/g or more and 1.0 m²/g or less.

The average particle size of the starting particles is a median diameter as measured using a particle size distribution analyzer MT3300EX from MicrotracBEL Corp.

The starting particles mainly include magnesium oxide (MgO). It is desirable for the starting particles to consist solely of MgO, but the effects of the present invention will be sufficiently exerted as long as the MgO content is 93 mass % or more, preferably 95 mas % or more, more preferably 97 mass % or more. In other words, it is permissible for the starting particles to contain impurities in proportions that do not interfere with the effects of the present invention. Such impurities include calcium compounds, silicon compounds, aluminum compounds, iron compounds, and boron compounds. The MgO purity of the starting particles is determined by the subtraction method, in which the concentrations of impurities, such as CaO, SiO₂, Fe₂O₃, Al₂O₃, and B₂O₃, measured by ICP-AES are subtracted from 100%.

The starting particles preferably comprise a sintered body of dead-burned magnesium oxide. Dead-burned magnesium oxide, also known as heavy-burned magnesium oxide or magnesia clinker, is obtained by firing magnesium hydroxide at or above 1400° C. The sintered body of dead-burned magnesium oxide is substantially inert and has high water resistance, high insulating properties, and high thermal conductivity. Since the starting particles comprise the sintered body of dead-burned magnesium oxide, the starting particles become magnesium oxide particles useful as a thermally conductive filler.

Apart from dead-burned magnesium oxide, light-burned magnesium oxide is also known. Light-burned magnesium oxide, which is also called calcined magnesium oxide, is obtained by firing magnesium hydroxide at 450° C. to 1300° C. Light-burned magnesium oxide differs from dead-burned magnesium oxide in that it has relatively high activity, low water resistance, and low thermal conductivity.

The starting particles can be polycrystalline or monocrystalline.

### 2. Magnesium Oxide Particles

The magnesium oxide particle of the present invention, which includes the spherical particle composed of a plurality of the starting particles, i.e., dead-burned magnesium oxide particles partially fused together, is then described.

The magnesium oxide particle of the present invention has a large number of voids. The presence of voids allows the magnesium oxide particles of the present invention to have a reduced apparent density. Because sintering between the starting particles hardly proceeds in the production steps hereinafter described, voids are maintained in the granulated particle, and the voids form open pores connected to the surface of the granulated particle.

The amount of the voids present in the magnesium oxide particles of the present invention in terms of porosity is preferably 10% or more and 50% or less, more preferably 10% or more and 45% or less, even more preferably 12% or more and 40% or less. When the magnesium oxide particles of the present invention has such high porosity, in the case that the magnesium oxide particles are composed into, e.g., a resin, the resulting resin composition exhibits high thermal conductivity, and an excessive increase in specific gravity of the resulting resin composition is suppressed.

The porosity is determined as follows. The magnesium oxide particles and a silicone resin KE-106 available from Shin-Etsu Chemical Co., Ltd. are mixed and molded into a 1 mm thick sheet. The sheet is polished using Cross Section Polisher from JEOL Ltd. to prepare a cross-section for SEM imaging. The cross-section is photographed under a scanning electron microscope MT400II from Hitachi Hi-Tech Corp to obtain an SEM image. The SEM image is analyzed using image analyzing software A-Zoukun from Asahi Kasei Engineering Corp. to measure the area ratios of magnesium oxide and voids which are area of the SEM image other than magnesium oxide in the cross-sections of the magnesium oxide particles to calculate porosity. The porosity (%) is defined to be the area of voids/(the area of magnesium oxide+the area of voids)×100.

Since the magnesium oxide particles of the present invention have voids including a large number of open pores, they have a large oil absorption. Oil absorption is a measure of the apparent density of particles. A higher oil absorption of the magnesium oxide particles of the present invention means a lower apparent density of the particles. From this viewpoint, the magnesium oxide particles of the present invention preferably have an oil absorption of 30 mL/100 g or more, more preferably 31 mL/100 g or more, even more preferably 32 mL/100 g or more. There is no specific upper limit to the oil absorption, but the practical upper limit may be, e.g., 40 mL/100 g.

The oil absorption is measured according to JIS K5101-13-1 using 5 g of the magnesium oxide particles and boiled linseed oil.

The magnesium oxide particles of the present invention, which are produced using dead-burned magnesium oxide as starting particles, have a small BET specific surface area and low activity. As a result, the magnesium oxide particles of the present invention have low reactivity with water and high water resistance. The BET specific surface area of the magnesium oxide particles of the present invention is preferably 0.05 m²/g or more and 2.0 m²/g or less, more preferably 0.05 m²/g or more and 1.0 m²/g or less, even more preferably 0.10 m²/g or more and 0.5 m²/g or less.

The BET specific surface area is measured by the single-point BET method using MonoSorb from Yuasa Ionics Co., Ltd. As a sample pretreatment, the sample is degassed at 180° C. for 10 minutes.

The magnesium oxide particle of the present invention is a spherical aggregate of a plurality of dead-burned magnesium oxide particles that are partially fused together. The phrase “partially fused” means that the primary particles, i.e., the dead-burned magnesium oxide particles are not completely fused together, but unfused portions are left, i.e., they are fused together while forming voids between the primary particles. The term “primary particles” is as defined above.

Since the magnesium oxide particles of the present invention are spherical, the magnesium oxide particles of the present invention can easily be highly filled into a resin. As a result, thermal conductivity of a resin composition is improved. From this viewpoint, the spherical magnesium oxide particles of the present invention preferably have a circularity of 0.7 or more, more preferably 0.72 or more, even more preferably 0.75 or more.

The circularity of the spherical magnesium oxide particles of the present invention is calculated from a projected image of the particles. Specifically, measurement was taken using a particle shape image analyzer PITA-3 from Seishin Enterprise Co., Ltd. A sample was prepared by dispersing 0.1 g of the magnesium oxide particles in 20 mL of a 0.2 mass % aqueous solution of sodium hexametaphosphate. To assure sufficient measurement accuracy, at least 3,000 particles are measured.

The spherical magnesium oxide particles of the present invention preferably have an average particle size D50 of 10 μm or more and 200 μm or less in terms of water resistance, and dispersibility and filling properties when the spherical magnesium oxide particles of the present invention are composed into resins. To ensure these advantages, the average particle size D50 is more preferably 20 μm or more and 150 μm or less, even more preferably 30 μm or more and 100 μm or less, still more preferably 40 μm or more and 60 μm or less.

As used herein, the average particle size D50 is a median diameter measured using a particle size distribution analyzer MT3300EX from MicrotracBEL Corp.

When the average particle size D50 of the magnesium oxide particles of the present invention is taken as D2 and the BET specific surface area-based equivalent particle size of the magnesium oxide particles of the present invention is taken as D1, the ratio of D2 to D1, D2/D1, is preferably from 3 or more and 10 or less in terms of high thermal conductivity, high porosity, and low apparent density. To further ensure these effects, the D2/D1 value is more preferably 3 or more and 9 or less.

While the preferred D2/D1 is in the above range, the D1 value itself, i.e., the BET specific surface area-based equivalent particle size is preferably 3.0 μm or more and 15 μm or less in terms of high thermal conductivity and a large circularity, provided that the D2/D1 falls within the above range. To further ensure the effects, D1 is more preferably 3.5 μm or more and 15 μm or less, even more preferably 4.0 μm or more and 15 μm or less.

### 3. Method for Producing Magnesium Oxide Particles

The method for producing the magnesium oxide particles of the present invention is next described. The method includes (1) a provision step of providing dead-burned magnesium oxide particles as starting particles, (2) a granulation step of granulating the starting particles, and (3) a firing step of firing the granulated particles. The method will be illustrated in step order.

### (1) Provision Step of Dead-Burned Magnesium Oxide as Starting Particles

Dead-burned magnesium oxide commercially available as electrofused magnesia or magnesia clinker can be used without particular limitation.

Dead-burned magnesium oxide is prepared by, for example, firing and pyrolyzing a magnesium salt, such as magnesium hydroxide, magnesium carbonate, magnesium chloride, magnesium nitrate, or magnesium sulfate.

The magnesium hydroxide can be a precipitate resulting from the reaction between a magnesium salt of sea water and calcium hydroxide.

The magnesium carbonate can be, for example, magnesite ore.

The method of firing magnesium hydroxide or magnesium carbonate is not particularly restricted, and a general firing furnace can be used to perform the firing.

The firing temperature is preferably 1300° C. or higher, more preferably 1300° C. or higher and 2800° C. or lower, even more preferably 1400° C. or higher and 2400° C. or lower.

The firing time should be sufficient for death-burned magnesium oxide to be produced, generally ranging from 10 minutes to 10 hours.

The thus obtained particles of the sintered body of dead-burned magnesium oxide is adjusted to primary particles with a desired average particle size by a particle size controlling step that combines milling and classification.

### Milling and Classification Steps:

The milling step can be selected appropriately according to the physical properties of the dead-burned magnesium oxide particles to be milled. For example, a crusher, such as a roll crusher or a jaw crusher, or a mill, such as a rotary ball mill, a vibrating ball mill, or a jet mill, or a combination thereof can be used. The classification step may be performed either after completion of the milling step or in combination with the milling step. The classification can be carried out using a vibrating screen, an air classifier, a cyclone classifier, or a combination thereof. Otherwise, a milling system including a classification mechanism can be used. As previously stated, the dead-burned magnesium oxide particles as starting particles resulting from the milling and classification steps preferably have an average particle size D50 of 1.0 μm or more and 20 μm or less, more preferably3.0 μm or more and 15.0 μm or less, even more preferably 5.0 μm or more and 10.0 μm or less.

### (2) Granulation Step

The dead-burned magnesium oxide as starting particles, which are obtained through the above-described milling and classification steps, are granulated into granulated particles of a predetermined size by spray drying in a granulation step. Granulation by spray drying can be achieved by, for example, atomizing a composition containing a suspension containing the dead-burned magnesium oxide as starting particles and a flux into hot air.

There is no particular limitation on the type of the flux to be used as long as it accelerates the grain growth of the dead-burned magnesium oxide as starting particles and assists in fusing the particles together at the firing temperature in the subsequent firing step. For example, fluxes that exhibit fluxing effects in the temperature range of from 1100° to 1700° C. are preferred in terms of the balance between fluxing effects and economy, and examples of the fluxes include lithium compounds, boron compounds, silicon compounds, and halogen compounds.

Examples of the lithium compounds as a flux include lithium hydroxide, lithium acetate, lithium nitrate, lithium sulfate, lithium oxide, lithium peroxide, lithium nitride, lithium sulfide, lithium metasilicate, titanium lithium oxide, lithium formate, lithium carbonate, lithium dodecylsulfate, lithium oxalate, lithium citrate, lithium lactate, lithium salicylate, lithium stearate, lithium tartrate, lithium hydroxybutyrate, lithium 2-ethylhexanoate, lithium cyclohexanoate, lithamide, lithium benzoate, lithium pyruvate, lithium cyclopentadienide, and lithium acetylacetonate.

Examples of the boron compounds include boric acid, boron oxide, boron hydroxide, boron nitride, boron carbide, and ammonium borate.

Examples of the silicon compounds include sodium silicate, silicon oxide, and polymethylsiloxane.

Examples of the halogen compounds include lithium fluoride and magnesium fluoride.

The fluxes recited above can be used either individually or in combination of two or more thereof.

The medium of the suspension containing the dead-burned magnesium oxide as starting particles and a flux can be, for example, water or an organic solvent. To achieve desirable granulation, the concentration of the dead-burned magnesium oxide in the suspension is preferably 10 mass % or more and 40 mass % or less, more preferably 15 mass % or more and 35 mass % or less.

For successful fusion of the dead-burned magnesium oxide in the subsequent firing step, the flux concentration of the suspension is preferably 0.1 mass % or more and 10 mass % or less, more preferably 1 mass % or more and 5 mass % or less, relative to the magnesium oxide.

The composition containing the suspension may contain a binder in addition to the dead-burned magnesium oxide as starting particles and the flux. Useful binders include polyacrylates, such as ammonium polyacrylate. To accomplish desirable granulation, the binder concentration in the suspension is preferably 0.1 mass % or more and 10 mass % or less, more preferably 1 mass % or more and 5 mass % or less, relative to the magnesium oxide.

The granulated particles (or granulation product) formed by the granulation step preferably have an average particle size of 20 μm or more and 300 μm or less, more preferably 30 μm or more and 200 μm or less, even more preferably 30 μm or more and 100 μm or less. The granulated particles are spherical porous particles having a plurality of open pores.

### (3) Firing Step of Granulation Product

The granulation product having open pores as obtained by the granulation step is fired in a firing step, and, as a result, the dead-burned magnesium oxide as starting particles constituting granulated particle are partially fused to one another. As a result, a single spherical magnesium oxide particle is obtained. Since the starting particles comprise dead-burned magnesium oxide, the firing causes only small changes in particle size, and the starting particles are partially fused to each other by the low-melting flux. As a result, voids form between the starting particles.

With the view of fusing the starting particles while leaving the pores of the dead-burned magnesium oxide granulation product open, the firing in the firing step is carried out at high temperatures, preferably 900° C. or higher and 1700° C. or lower, more preferably 1000° C. or higher and 1600° C. or lower. Various types of firing furnaces may be used to achieve such high temperatures. The heat source of the firing furnace is not particularly limited as long as the requisite temperatures are achieved. For example, an electric furnace or a gas furnace may be used depending on the scale of production. The firing temperature and time are selected appropriately according to the type and amount of the flux.

### 4. Thermally Conductive Filler

The thus produced magnesium oxide particles are suited for use as a thermally conductive filler because of the high thermal conductivity of the dead-burned magnesium oxide. The thermally conductive filler can be mixed with various resins to provide resin compositions. Since the thermally conductive filler is spherical, the thermally conductive filler can be composed into resins at high filler loading ratios. In addition, spherical particles are more likely to maintain their shape during kneading with a resin as compared with other particles, such as acicular particles.

The thermally conductive filler comprising the magnesium oxide particles of the present invention achieves a thermal conductivity as high as 1.2 W/mK or more when filled into a resin at a ratio of 40 vol %.

The thermal conductivity of the magnesium oxide particles is determined as follows. The magnesium oxide particles and a silicone resin KE-106 from Shin-Etsu Chemical Co., Ltd. are mixed and molded into a 1 mm thick sheet. The thermal conductivity of the sheet is measured using a thermal conductivity meter TPS2500 S from Kyoto Electronics Mfg. Co., Ltd. The magnesium oxide particles are mixed with the silicone resin at a volume ratio of 40%, which represents the volume occupied by the magnesium oxide excluding the voids.

### 5. Thermally Conductive Resin Composition

The thermally conductive filler of the present invention can be composed into a resin to provide a resin composition with increased thermal conductivity. The thermally conductive filler of the present invention may be used in combination with other particulate materials, such as silicon oxide, aluminum oxide, magnesium oxide, silicon nitride, aluminum nitride, and boron nitride. The other material particles to be combined may be spherical like the thermally conductive particles of the present invention or may have other shapes.

The resin that can be filled with the thermally conductive filler of the present invention is selected as appropriate to the end use. Applicable resins include, for example, silicon oils or greases, thermosetting resins, such as epoxy resins, and thermoplastic resins, such as polyamide resins, polyphenylene sulfide resins and liquid crystal polymers.

The compounding ratios in the resin composition are 1 mass % or more and 90 mass % or less of the thermally conductive filler and 10 mass % or more and 99 mass % or less of the resin, relative to the total mass (100 mass %) of the resin composition. A resin compounding at least 1 mass % of the thermally conductive filler results in a resin composition with a sufficiently increased thermal conductivity. Compounding 90 mass % or less of the thermally conductive filler achieves both sufficient thermal conductivity and retention of the resin characteristics.

Notably, the thermally conductive filler of the present invention makes it possible to achieve the same thermal conductivity enhancement effect with a smaller amount of addition as compared with conventional thermally conductive fillers containing magnesium oxide.

The resin composition containing the thermally conductive filler of the present invention is prepared by mixing the filler into a resin by any known method. The resulting thermally conductive resin composition can be molded by known methods, such as extrusion, and formed into a desired shape.

In order to improve the dispersibility and miscibility in mixing the thermally conductive filler and resins and to improve the mechanical properties of the resulting resin compositions, the thermally conductive filler may be surface treated. Examples of compounds for the surface treatment include: silane coupling agents having a vinyl group, alkyl group, phenyl group, amino group, or phenylamino group; metal soaps, such as magnesium stearate; and surfactants, such as sodium stearate. The surface treatment of the thermally conductive filler may be performed by mixing the filler with the surface treating agent prior to the kneading with a resin or by the integral blending method in which the surface treatment agent is added at the time the resin and the filler are mixed.

The resin composition containing the thermally conductive filler of the present invention is applicable to various articles, particularly suitable for applications to those articles requiring high thermal conductivity and high moisture resistance. Such articles include lamp sockets and various electrical components in automobiles; and heat sinks, die pads, printed wiring boards, semiconductor packaging components, cooling fan components, pickup components, connectors, switches, bearings, and case housings in electronic equipment.

The thermally conductive filler of the present invention is also suitable for use in components requiring weight reduction because of its ability to impart high thermal conductivity to resins at low addition levels.

### EXAMPLES

The present invention will now be illustrated in greater detail with reference to Examples for illustrative purpose only. It should be noted that the present invention is not deemed to be limited thereto. Unless otherwise specified, all the percentages are given by mass.

### Example 1

Sintered bodies of dead-burned magnesium oxide (magnesia clinker manufactured by Ube Material Industries, Ltd., UBE995S (MgO purity: 99.5%)) was crushed to 1 mm or finer using a roll crusher MRCA-O from Makino Corp, and then milled using a cyclone mill 250BMS from Shizuoka Plant Co., Ltd to obtain dead-burned magnesium oxide particles.

The dead-burned magnesium oxide particles were classified in an air classifier CFA100 from Ashizawa Finetech Ltd. to remove coarse particles of 20 μm or greater and recover fine particles with an average particle size of 6 μm for use as starting particles.

Five hundred grams of the dead-burned magnesium oxide as starting particles were dispersed in 1417 g of ion-exchanged water along with 8.9 g of ammonium polyacrylate and 14.5 g of lithium hydroxide to prepare a suspension. The suspension was granulated by spray drying to obtain spherical granulated particles with an average particle size of 49 μm. The spray drying granulation was performed using a spray dryer FL-11 from Ohkawara Kakohki Co., Ltd. under conditions of 14000 rpm in disk rotation speed, 220° C. in inlet temperature, and 105° C. in outlet temperature.

The spherical granulated particles were fired in the air atmosphere at 1300° C. for 2 hours in an electric furnace KL-2030D from Motoyama Co., Ltd. The fired product was crushed in a mortar and sieved through a 75-μm sieve to collect spherical porous magnesium oxide particles.

### Example 2

Spherical porous magnesium oxide particles were produced in the same manner as in Example 1, except for using sintered bodies of dead-burned magnesium oxide (magnesia clinker manufactured by Ube Material Industries, Ltd., UBE 975 (MgO purity: 97.5%)) as a sintered body of dead-burned magnesium oxide.

### Comparative Example 1

In this comparative example, magnesium oxide manufactured by Ube Material Industries, Ltd.,RF-98 (average particle size: 56.6 μm) as a thermally conductive filler was used.

### Comparative Example 2

Five hundred grams of hexagonal plate shape magnesium oxide particles (MgO purity after ignition: 98.2%; average particle size: 2 μm) was dispersed in 1423 g of ion-exchanged water together with 8.9 g of ammonium polyacrylate and 10 g of lithium hydroxide to prepare a suspension. The suspension was granulated by spray drying in the same manner as in Example 1 to form spherical granulated particles with an average particle size of 5 μm.

The spherical granulated particles were fired in the air atmosphere at 1300° C. for 2 hours in an electric furnace KL-2030D from Motoyama Co., Ltd., crushed in a mortar, and sieved through a 75-μm sieve to obtain magnesium oxide particles.

### Comparative Example 3

Five hundred grams of hexagonal plate shape magnesium oxide particles (MgO purity after ignition: 98.2%; average particle size: 4.0 μm) was dispersed in 1423 g of ion-exchanged water together with 8.9 g of ammonium polyacrylate to prepare a suspension. The suspension was granulated by spray drying in the same manner as in Example 1 to form spherical granulated particles with an average particle size of 55 μm.

The spherical granulated particles were fired in the air atmosphere at 1300° C. for 2 hours in an electric furnace KL-2030D from Motoyama Co., Ltd., disintegrated in a mortar, and sieved through a 75-μm sieve to obtain magnesium oxide particles.

### Evaluation

The magnesium oxide particles obtained in Examples and Comparative Examples were evaluated by determining the BET specific surface area, BET specific surface area-based equivalent particle size D1, average particle size D2, oil absorption, thermal conductivity, circularity, and porosity according to the methods described above. The results obtained are shown in Table 1.

TABLE 1

| | Example | | Comparative Example | | |
|---|---|---|---|---|---|
| | 1 | 2 | 1 | 2 | 3 |
| BET specific surface area | 0.30 | 0.12 | 0.08 | 0.10 | 0.79 |
| (m²/g) | | | | | |
| BET specific surface | 5.59 | 13.97 | 20.95 | 16.76 | 2.12 |
| area-based equivalent | | | | | |
| particle size D1 (μm) | | | | | |
| Average Particle Size D2 (μm) | 49.0 | 55.0 | 56.6 | 48.0 | 50.0 |
| D2/D1 | 8.8 | 3.9 | 2.7 | 2.9 | 23.6 |
| Oil Absorption (ml/100 g) | 35 | 31 | 29 | 21 | 45 |
| Thermal Conductivity | 1.42 | 1.31 | 0.96 | 1.12 | 1.02 |
| (W/mK) | | | | | |
| Circularity | 0.84 | 0.77 | 0.72 | 0.85 | 0.87 |
| Porosity (% | 34 | 16 | 0 | 4 | * |

* Unmeasurable because the primary particles were smaller than the resolution of the image analysis

### INDUSTRIAL APPLICABILITY

The present invention provides magnesium oxide particles that are easily kneadable into resins and, when composed into resins even at not so high filling ratios, exhibit high thermal conductivity and do not result in excessively high specific gravity of the resulting resin compositions; and a method for producing the same.

1. A magnesium oxide particle comprising a spherical particle,
the spherical particle comprising a plurality of dead-burned magnesium oxide particles,
the dead-burned magnesium oxide particles being partially fused together in such a manner that open pores remain between the dead-burned magnesium oxide particles,
the spherical particle having an average particle size (D2) of 10 μm or more and 200 μm or less, and
the spherical particle having a projected image having a circularity of 0.7 or more.

2. The magnesium oxide particle according to claim 1, wherein the spherical particle has a BET specific surface area-based equivalent particle size (D1) of 3.0 μm or more and 15 μm or less.

3. The magnesium oxide particle according to claim 1 or 2, having a porosity of 10% or more and 50% or less, wherein the porosity is determined by image analysis.

4. The magnesium oxide particle according to claim 1 or 2, having a ratio of the average particle size D2 to the BET specific surface area-based equivalent particle size D1, D2/D1, of 3 or more and 10 or less.

5. The magnesium oxide particle according to claim 1 or 2, having an oil absorption of 30 mL/100 g or more, wherein the oil absorption is measured in accordance with JIS K5101-13-1.

6. A method for producing magnesium oxide particles, comprising
granulating a raw material composition comprising: dead-burned magnesium oxide particles having an average particle size of 1.0 μm or more and 20.0 μm or less; and a flux to form granulated particles, and
firing the granulated particles at 900° C. or higher and 1700° C. or lower.

7. The method for producing magnesium oxide particles according to claim 6, wherein the flux is a lithium compound, a boron compound, a silicon compound, or a halogen compound.

8. A thermally conductive filler comprising a spherical particle,
the spherical particle comprising a plurality of dead-burned magnesium oxide particles,
the dead-burned magnesium oxide particles being partially fused together in such a manner that open pores remain between the dead-burned magnesium oxide particles,
the spherical particle having an average particle size (D2) of 10 μm or more and 200 μm or less, and
the spherical particle having a projected image having a circularity of 0.7 or more.

9. A resin composition comprising the thermally conductive filler according to claim 8 and a resin.
